(19) United States
(12) Patent Application Publication
(10) Pub. No.: US 2007/0026932 A1
(43) Pub. Date: Feb. 1, 2007

(54) Gaming machine

(75) Inventor: Kazunobu Sato, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Aruze Corp., Tokyo (JP)

(21) Appl. No.: 11/493,933

(22) Filed: Jul. 27, 2006

(30) Foreign Application Priority Data
Aug. 1, 2005 (JP) P2005-222946

(51) Int. Cl. A63F 13/00

(52) U.S. Cl. 463/20

(57) ABSTRACT

A gaming machine for playing a variable display game comprises a display and a processor. The display includes a first display area which displays the plurality of symbols in a variable state and in a stopped state, and a second display area occupying at least a part of a display area other than the first display area. The processor determines whether or not a combination of stopped symbols displayed in the stopped state in the first display area is a specific combination, and controls the display to display the specific combination in the second display area in another variable display game after the variable display game in which the specific combination is displayed in a stopped state in the first display area.

### CROSS REFERENCE TO RELATED APPLICATIONS

This application is based upon and claims the benefit of priority from the prior Japanese Patent Application No. 2005-222946, filed on Aug. 1, 2005; the entire contents of which are incorporated herein by reference.

### BACKGROUND OF THE INVENTION

1. Field of the Invention

The present invention relates to a gaming machine capable of variable display game such as a slot machine or a so-called Pachinko-slot machine (Japanese slot machine).

2. Related Background of the Invention

A gaming machine capable of variable display game has been known that a symbol is variably displayed by rotating a plurality of reels on which a plurality of symbols or a plurality of variable display images is displayed. One example of such gaming machines is a machine which is provided with a main display and a sub display, and in which a base variable display game is played on the main display, while another game is played on the sub display using a game history played with the main display. For example, Japanese Patent Application Laid-Open No. 2004-194737 describes a gaming machine in which an image displayed based on the game history of a variable display game having been played with the main display (hereinafter referred to as “history image”) is displayed on the sub display, and additional winning occurs when the history image becomes a predetermined mode.

On the other hand, some other gaming machines which are not capable of a variable display game display names and scores of the players who won high scores in the game after the game is finished.

### SUMMARY OF THE INVENTION

An object of the present invention is to provide a gaming machine that the past game results can be grasped easily and that players hardly get tired of playing games.

A gaming machine of the present invention is for playing a variable display game by variably displaying a plurality of symbols. The gaming machine comprises: a display means including a first display area which displays the plurality of symbols in a variable state and in a stopped state, and a second display area occupying at least a part of a display area other than the first display area; a winning combination determining means for determining whether or not a combination of stopped symbols displayed in the stopped state in the first display area is a specific combination; and a display control means for displaying the specific combination in the second display area in another variable display game after the variable display game in which the specific combination is displayed in a stopped state in the first display area.

### BRIEF DESCRIPTION OF THE DRAWINGS

FIG. 1 is a perspective view showing an entire construction of a slot machine, which is a gaming machine according to an embodiment of the present invention;

FIG. 2 is a block diagram of the slot machine mainly showing an internal configuration;

FIG. 3 is a block diagram showing an example of an internal configuration of an image control circuit;

FIG. 4 is a flowchart showing an operation procedure from start to end of a game of the slot machine;

FIG. 5 is a flow chart showing an operation procedure of base game process;

FIG. 6 is a diagram showing examples of a winning combination history table;

FIG. 7 is a diagram showing an example of a table used for determination of a winning combination;

FIG. 8 is a view showing an image display area of a main display;

FIG. 9 is a view showing an example of a ranking image displayed on a sub display;

FIG. 10 is a diagram showing an example of contents of a stop table;

FIG. 11 is a perspective view showing an entire construction of a reel-type slot machine;

FIG. 12 is a perspective view showing a construction of a reel in the reel-type slot machine; and

FIG. 13 is a perspective view showing a schematic construction of a liquid crystal display device seen from the back side of a cabinet in the reel-type slot machine.

### DESCRIPTION OF THE PREFERRED EMBODIMENTS

(Entire Construction of a Slot Machine)

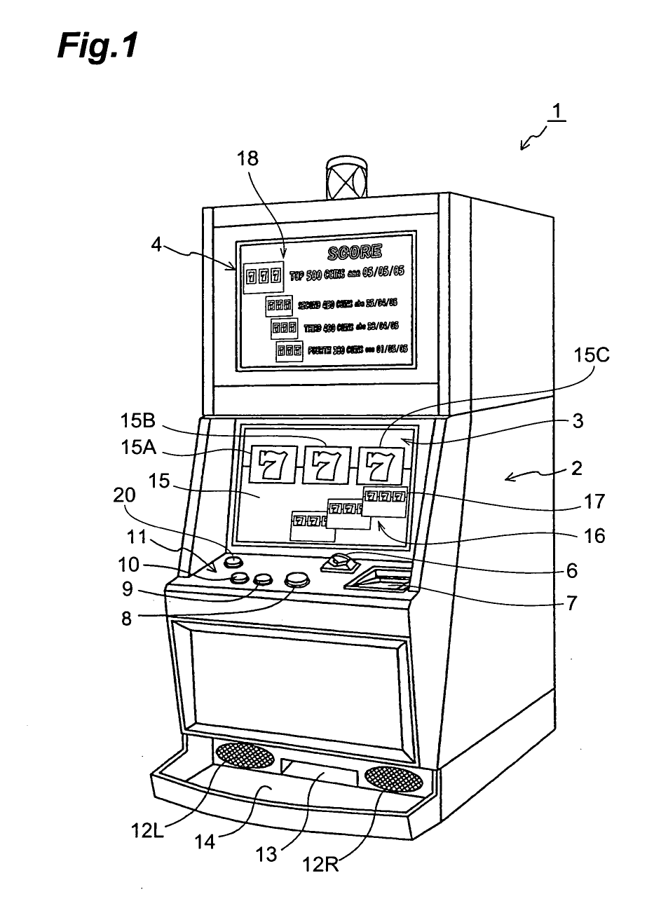

FIG. 1 is a perspective view showing an entire construction of a slot machine 1. The slot machine 1 is a gaming machine according to an embodiment of the present invention and is constituted so that a variable display game (also referred to as a slot game) using a variable display image of a plurality of symbols can be played. The slot machine 1 provides a player with a base game started unconditionally from the game start as well as a bonus game started under a certain condition subsequent to the base game, and in the bonus game, a free game can be played.

The slot machine 1 has a main display 3 provided with a liquid crystal display device on the front of a cabinet 2. The slot machine 1 also has a sub display 4 similarly provided with a liquid crystal display device on an upper part of the main display 3.

The main display 3 is a display means in the present invention and has an image display area 15 including a plurality of symbol areas 15A, 15B and 15C on the screen. The plurality of symbol areas constitute a first display area of the main display 3. The first display area is adapted to display the variable display game and displays symbols in a variable state and a stopped state. Specifically, this main display 3 performs variable display of symbols by displaying a scroll display image as if a plurality of symbols are moving from up to down (reel image visually recognized as if a mechanical reel is rotating) until the scroll display image is changed into a stopped image of the symbols in each of the symbol areas 15A to 15C of the image display area 15 in the base game. Also, the image display area 15 of the main display 3 has a history display area 16 as a second display area for displaying a winning combination history image 17, which will be described later, at a lower part of the symbol areas 15A to 15C. As shown in FIG. 1, the history display area 16 (second display area) occupies at least a part of the image display area 15 other than the symbol areas 15A to 15C (first display area) in the image display area 15 of the main display 3. In other words, the history display area 16 (second display area) is positioned in an area except for the symbol areas 15A to 15C (first display area).

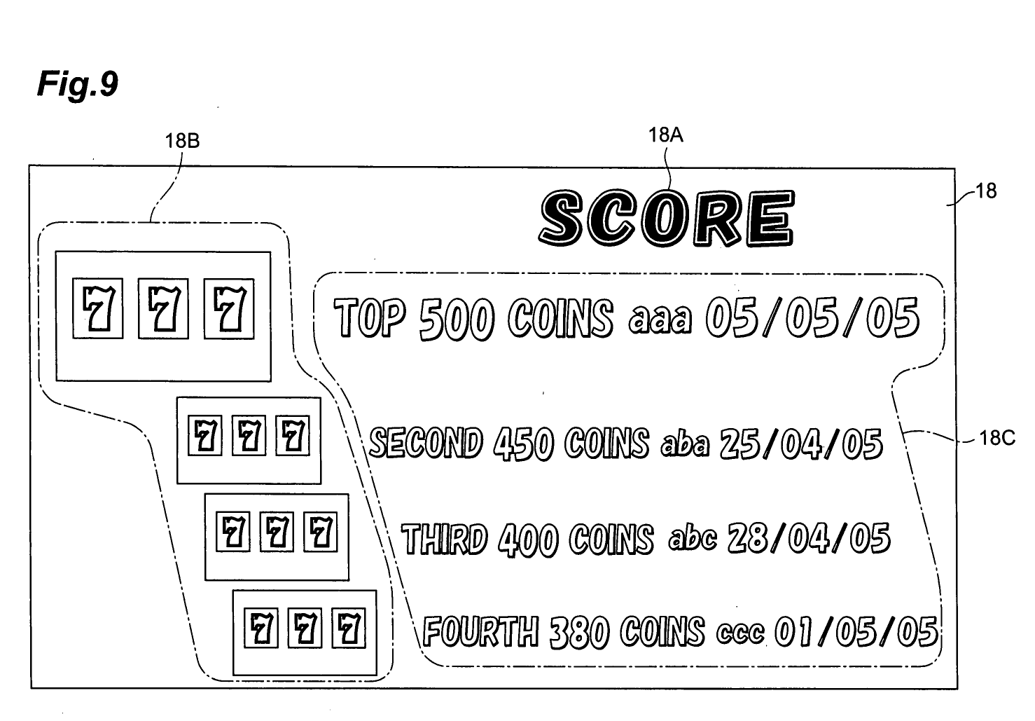

The sub display 4 displays an image relating to a game such as a payout table, explanation of the game or the like (explanation of the game contents, for example) and a ranking image 18 (See FIG. 9), which will be described later.

The slot machine 1 is provided with a substantially horizontal operation table 11 on a lower side of the main display 3. On the operation table 11, a coin slot 6, a bill insertion slot 7, a spin switch 8, a 1-BET switch 9, a maximum BET switch 10 and a history reset switch 20 are provided.

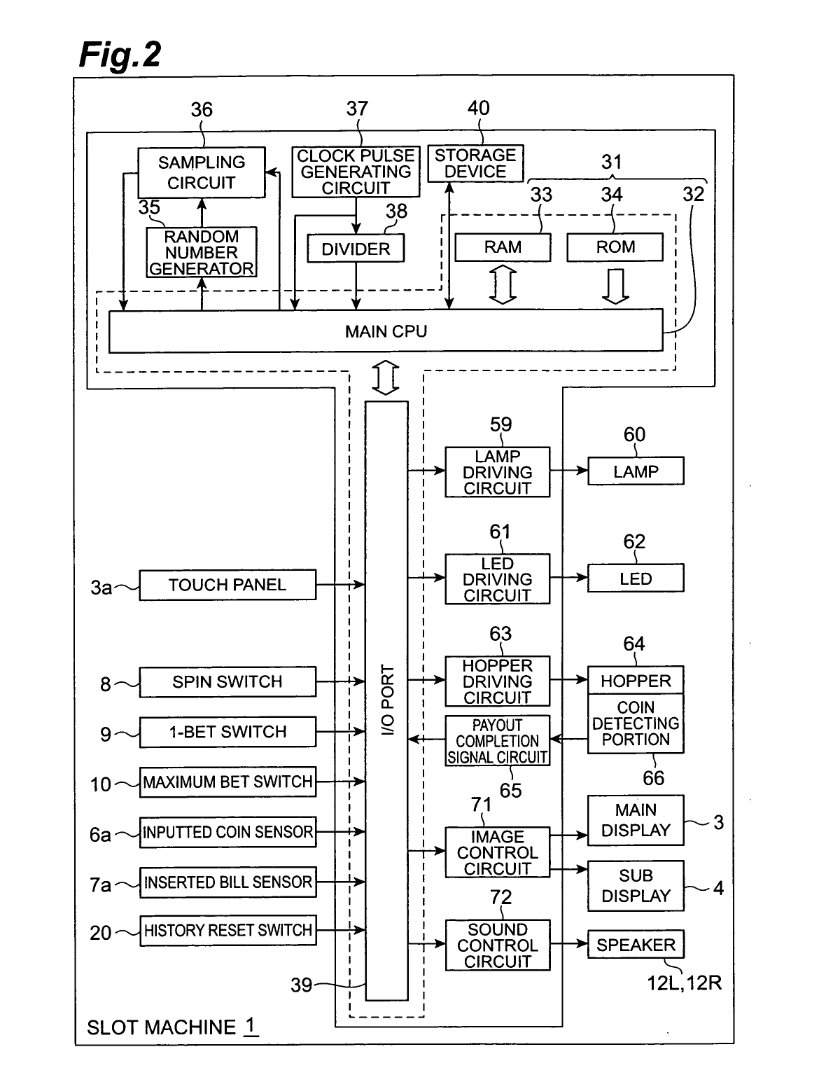

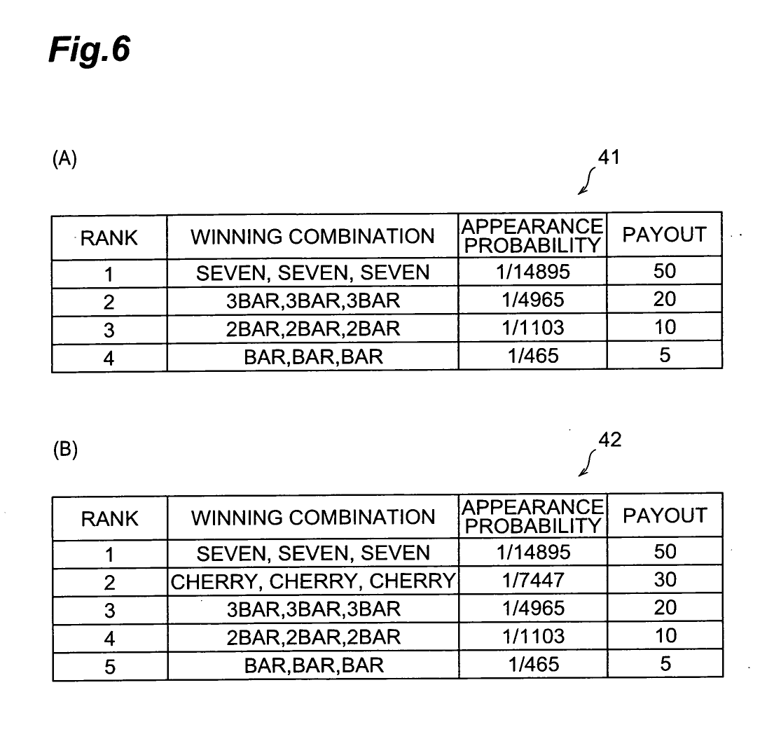

The coin slot 6 is provided for a player to put in a coin to bet on a game and has an inputted coin sensor 6a (See FIG. 2) for outputting a signal indicating input of a coin. Also, the bill insertion slot 7 is provided for a player to put in a bill and has an inserted bill sensor 7a (See FIG. 2) for outputting a signal indicating bill insertion. The spin switch 8 is provided for a player to carry out start operation (pressing-down operation) to start a slot game by starting variable display of symbols in the respective symbol areas 15A to 15C. The 1-BET switch 9 is provided for setting a bet of a single coin by a single operation. The maximum BET switch 10 is provided for setting a bet of the maximum number of coins which can be bet on one game by a single operation. The history reset switch 20 outputs to a main CPU 32, which will be described later, a reset signal to initialize a winning combination history table 41 (See FIG. 6) stored in a storage device 40, which will be described later, when the history reset switch 20 is pressed down.

Moreover, in the slot machine 1, a coin payout port 13 and a coin receiver 14 for receiving paid-out coins are provided at a bottom portion of the cabinet 2. Furthermore, speakers 12L, 12R are provided at right and left with the coin paying-out port 13 between them, respectively.

FIG. 2 is a block diagram of the slot machine 1 mainly showing the internal configuration. The slot machine 1 has a plurality of components including a microcomputer 31 as the processor in the present invention.

The microcomputer 31 has a main Central Processing Unit (CPU) 32, a Random Access Memory (RAM) 33 and a Read Only Memory (ROM) 34. The main CPU 32 is operated as various means characterizing the present invention according to a program stored in the ROM 34 while carrying out operation control of the entire slot machine 1 by input and output of signals with other components through an I/O port 39. The RAM 33 stores data and programs used when the main CPU 32 is operated, and random number values sampled by a sampling circuit 36, which will be described later, are temporarily stored after a game start, for example. The ROM 34 stores programs to be executed by the main CPU 32 and permanent data.

Also, the slot machine 1 has a random number generator 35, the sampling circuit 36, a clock pulse generating circuit 37, a divider 38 and the storage device 40. The random number generator 35 operates according to an instruction of the main CPU 32 and generates random numbers in a certain range. The sampling circuit 36 extracts an arbitrary random number among the random numbers generated by the random number generator 35 according to the instruction of the main CPU 32 and inputs the extracted random number into the main CPU 32. The clock pulse generating circuit 37 generates a reference clock to operate the main CPU 32, and the divider 38 inputs a signal obtained by dividing the reference clock by a certain cycle into the main CPU 32. The storage device 40 corresponds to a winning combination storing means and stores the winning combination history table 41 as shown in FIG. 6. This winning combination history table 41 stores winning combinations, their appearance probabilities and payouts according to the priority order, which will be described later.

Moreover, the slot machine 1 has a touch panel 3a, a lamp driving circuit 59, a lamp 60, an LED driving circuit 61, an LED 62, a hopper driving circuit 63, a hopper 64, a payout completion signal circuit 65, and a coin detecting portion 66. Also, the slot machine 1 has an image control circuit 71 and a sound control circuit 72.

The touch panel 3a is provided covering a display screen of the main display 3 and detects a position of a spot touched by a finger of a player and inputs a position signal corresponding to the detected position into the main CPU 32. The lamp driving circuit 59 outputs to the lamp 60 a signal for lighting the lamp 60 and flashes the lamp 60 while the game is being played. The game is staged by this flashing. The LED driving circuit 61 controls flashing display of the LED 62. The LED 62 displays the number of credits, the number of won coins and the like. The hopper driving circuit 63 drives the hopper 64 according to control of the main CPU 32, and the hopper 64 operates payout of coins and pays out coins from the payout port to the coin receiver 14. The coin detecting portion 66 counts the number of coins paid out by the hopper 64 and notifies data on a value of the counted number to the payout completion signal circuit 65. The payout completion signal circuit 65 receives the data on the value of the number of coins from the coin detecting portion 66 and inputs a signal notifying coin payout completion to the main CPU 32 when the value of the number of coins reaches the data of the set number.

The image control circuit 71 controls image display on the main display 3 and the sub display 4, respectively, and has various images such as variable display images of a plurality of symbols displayed on the main display 3 and the sub display 4. This image control circuit 71 functions as the processor together with the microcomputer 31 in the present invention.

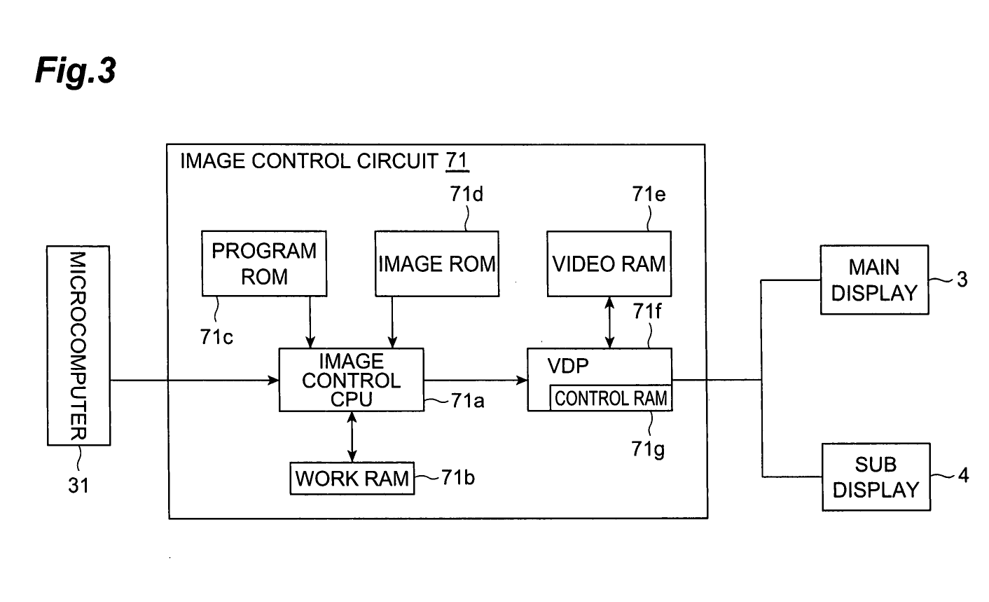

This image control circuit 71 has, as shown in FIG. 3, an image control CPU 71a, a work RAM 71b, a program ROM 71c, an image ROM 71d, a video RAM 71e and a Video Display Processor (VDP) 71f. The image control CPU 71a determines an image (reel images, images of symbols displayed when scroll display is stopped) displayed on the main display 3 and the sub display 4 according to the image control program (relating to display on the main display 3 and the sub display 4) stored in advance in the program ROM 71c based on parameters set by the microcomputer 31. The work RAM 71b is constituted as temporarily storing means when the image control CPU 71a executes the image control program. With the configuration as mentioned above, the image control circuit 71 functioning as the processor is in communication with the main display 3 and the sub display 4.

The program ROM 71c stores image control programs and various selection tables. The image ROM 71d stores dot data for forming an image. This dot data include symbol image data showing each symbol used in the base game and the bonus game in this embodiment. The video RAM 71e is constituted as a temporary storing means when forming an image by the VDP 71f. The VDP 71f has a control RAM 71g and forms an image according to the display contents of the main display 3 and the sub display 4 determined by the image control CPU 71a. Also, the VDP 71f outputs the respective formed images to the main display 3 and the sub display 4.

The sound control circuit 72 inputs a sound signal for outputting sound from the speakers 12L, 12R into the speakers 12L, 12R. For example, sound to boost the game is outputted at an appropriate timing after the game was started.

(Operation of the Slot Machine)

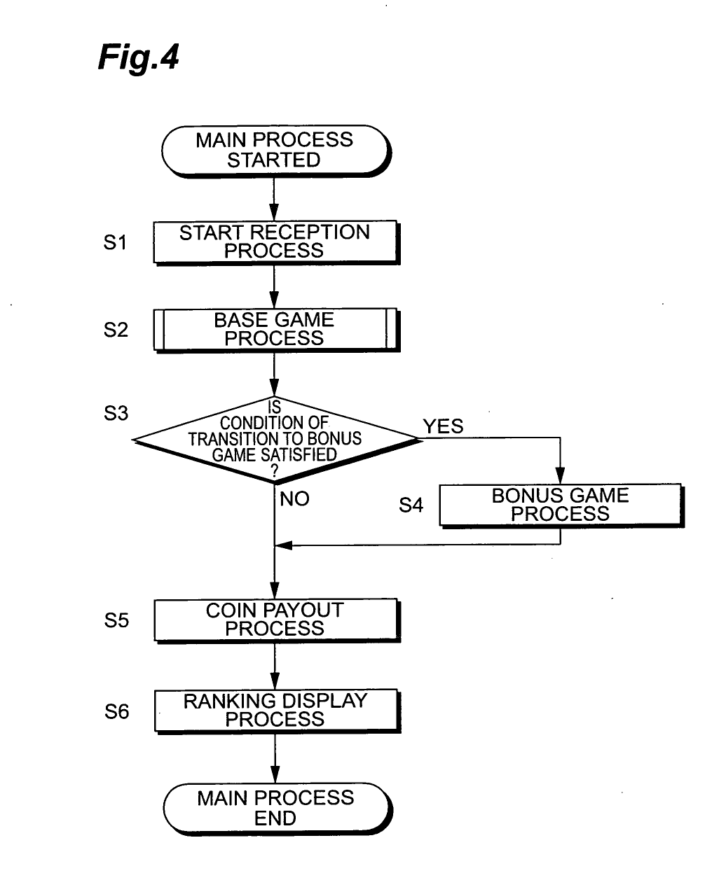

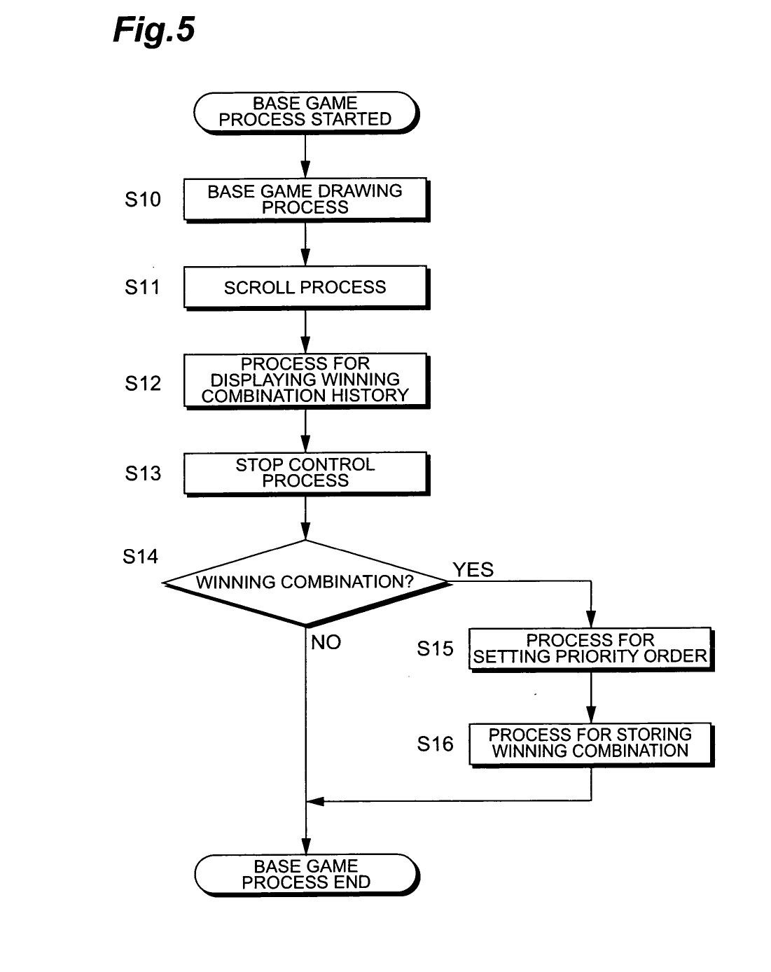

Next, the operation of the slot machine 1 having the above configuration will be described referring to the flowcharts shown in FIGS. 4 and 5. In the slot machine 1, as shown in FIG. 4, first, the base game process is executed after start reception process and then, the bonus game process is executed under a certain condition.

FIG. 4 is a flowchart showing an operation procedure of a main process from start to end of a game in the slot machine 1, and FIG. 5 is a flowchart showing an operation procedure of the base game process. It is to be noted that a step is abbreviated as S in FIGS. 4 and 5.

In the slot machine 1, the main CPU 32 operates as a game process control means and controls the game process. At this time, when the main process is started as shown in FIG. 4, the slot machine 1 executes the start reception process at Step 1 at start of the game, and at the subsequent Step 2, the base game process is carried out while the game mode is still in the base game and the program proceeds to Step 3. At Step 3, upon receipt of a result of the base game drawing process, which will be described later, in the base game process in Step 2, the main CPU 32 operates as a transition determining means and determines availability of transition to the bonus game (the special game) according to a transition condition to make the game mode transit to the bonus game. Here, if the transition condition is satisfied and determined that the transition is allowed, the main CPU 32 operates as the transition means and the program proceeds to Step 4 to make the game mode transit to the bonus game and then, to Step 5. However, if the transition condition is not satisfied, the program proceeds to Step 5 without executing Step 4. After going on to Step 5, when a prize is won in the base game or the bonus game, coin payout process according to the winning combination (coin payout instruction by the main CPU 32 to the hopper driving circuit 63 according to the number of paying out, payout of coins by the hopper 64 and signal input from the payout completion signal circuit 65) is executed. After that, the ranking image 18 (See FIG. 9) showing information of the top 4 cases with high payouts (scores) is displayed on the sub display 4, and the main process is ended. Details of each block will be described below.

If a player presses and operates the history reset switch 20 at start of the game, the reset signal is inputted into the main CPU 32 and the winning combination history table 41, which will be described later, stored in the storage device 40 is initialized. Then, when the player repeatedly plays the variable display game by the slot machine 1 and won the base game, a specific combination (for example, a winning combination indicating the variable display game was won) among combinations of stopped symbols displayed in a stopped state in the image display area 15 is stored in the winning combination history table 41. In the description below, such a case is assumed that the player has already played the variable display game repeatedly by the slot machine 1 and won some base games. Here, the “stopped symbols” means symbols displayed in a stopped state. Accordingly, the “stopped symbols” stored in the winning combination history table 41 are symbols already displayed in the variable display game and stored if a player wins a variable display game. Further, though the winning combinations is exemplified in the following explanation, the winning combination history table 41 is not only for storing winning combinations, but also for storing specific combinations prescribed beforehand in the ROM 34 or the storage device 40.

First, proceeding to the start reception process at Step 1, the slot machine 1 receives operation to start the game from a player according to control of the main CPU 32. Since the slot machine 1 is a coin-input type gaming machine, the player puts in the number of coins to bet on one game through the coin slot 6 in order to start the game and operates the 1-BET switch 9 or the maximum BET switch 10 when some credits are left. Then, the player operates the spin switch 8 (these operations shall be hereinafter referred to as “start operation”). By this start operation, the start signal is inputted from the spin switch 8 to the CPU 32.

When the start reception process is finished, the program proceeds to Step 2, where the base game process is carried out along the flowchart shown in FIG. 5. When the base game process is started, the program proceeds to Step 10, where the base game drawing process is carried out. In this base game drawing process, the main CPU 32 operates as a stop symbol determining means and carries out symbol determining process. In this symbol determining process, the main CPU 32 determines a symbol to be displayed in a stopped state after variable display is stopped in each of the symbol areas 15A to 15C (this symbol shall be hereinafter referred to as “stopped symbol”). In the slot machine 1, the main CPU 32 instructs the image control circuit 71 during this base game drawing process to display an image to stage the game on the sub display 4.

In this base game drawing process, upon receipt of detection of the start operation by the player by the start signal (that is, with the game start as a trigger), the main CPU 32 instructs the random number generator 35 to generate a certain range of random numbers. Also, the main CPU 32 instructs the sampling circuit 36 to extract an arbitrary random number from the random numbers generated by the random number generator 35. When the random number is extracted, the main CPU 32 sets the random number to a search key and obtains a code No. of the applicable symbol by referring to a symbol determining table, not shown, stored in the ROM 34 (table storing the code numbers of the symbols and random numbers in association).

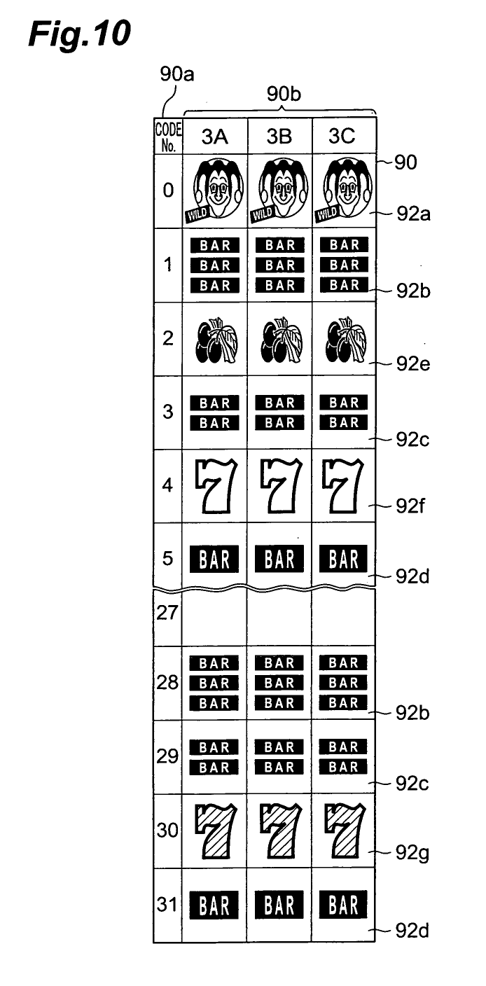

Next, the main CPU 32 sets the obtained code No. to a search key and searches a stopped symbol displayed in a stopped state on each of the symbol areas 15A to 15C in the image display area 15 by referring to a stop table as shown in FIG. 10 (table storing the code Nos. of the symbols and applicable symbols in association).

Here, a stop table 90 has a code No. area 90a for storing code Nos. (of symbols) and a symbol area 90b for storing symbols corresponding to the respective code Nos., and applicable symbols can be searched for each of the symbol areas 15A to 15C by searching the code No. area 90a by setting the code No. to a search key.

The symbol area 90b registers (codes of) each symbol corresponding to each code No. from “0” to “31”. The symbol area 90b registers (codes of) each symbol displayed in a stopped state in each of the symbol areas 15A to 15C. In this embodiment, a symbol corresponding to the code No. “0” (Wild joker 92a) in the symbol area 90b is a beneficial symbol. This Wild joker 92a has a meaning to indicate to players that this symbol is more beneficial than the other symbols and consists of an image representing a human face and a character string of “WILD” in combination as shown in FIG. 10. Moreover, the symbols corresponding to the code Nos. “1”, “28” are 3BAR 92b, symbols corresponding to the code Nos. “3”, “29” are 2BAR 92c, and the symbols corresponding to the code Nos. “5”, “31” are BAR 92d. Also, the symbol corresponding to the code No. “2” is a cherry 92e, the symbol corresponding to the code No. “4” is a seven 92f, and the symbol corresponding to the code “30” is RED seven 92g shown in red.

In the description below, a case where the cherry 92e is determined as the stopped symbol for each symbol area will be described as an example.

Then, when the stopped symbol in the respective symbol areas 15A to 15C is determined, the main CPU 32 determines if it is winning or not by referring to the winning determining table stored in the ROM 34. The winning determining table registers either of a winning combination and a non-winning combination based on criteria of winning or not in association with combinations of each code No. (hereinafter referred to as “code No. pattern”). Since a code No. pattern corresponding to the stopped symbol has been determined, the main CPU 32 sets the code No. pattern corresponding to the stopped symbol to a search key and by referring to the winning determining table, determines if the variable display game was won or not from the referred results. Here, when it was determined that the variable display game was won, the main CPU 32 sets “1” to a winning combination flag used for determination of winning combination or not, which will be described later, while it sets “0” for the other cases. In this embodiment, it was determined that the cherry 92e is displayed in a stopped state in the respective symbol areas 15A to 15C, and the main CPU 32 determines that the variable display game was won and sets “1” to the winning combination flag.

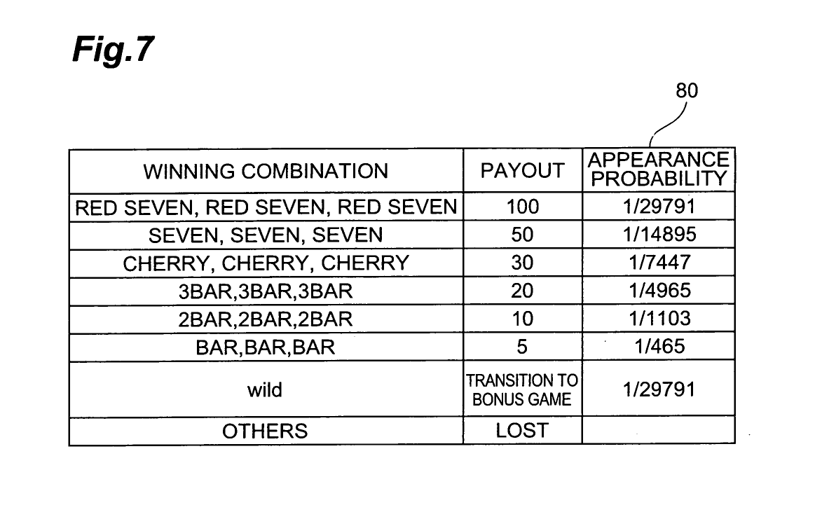

Then, the main CPU 32 refers to the combination table and carries out the winning combination determining process to determine the winning combination to decide on payouts. A combination table 80 is to determine a winning combination as shown in FIG. 7, and payouts corresponding to each winning combination are registered. Also, the combination table 80 registers probabilities to become each winning combination, that is, appearance probabilities indicating difficulty of formation of the combination of the stopped symbols displayed in the respective symbol areas 15A to 15C. In this embodiment, since it was determined that the cherry 92e is displayed in a stopped state in the respective symbol areas 15A to 15C, it falls under “cherry, cherry, cherry”, which is determined as payouts of 30 coins and the appearance probability of “1/7447”.

When the winning combination determining process is finished, the base game drawing process is finished. Then, the scroll process at Step 11 is executed.

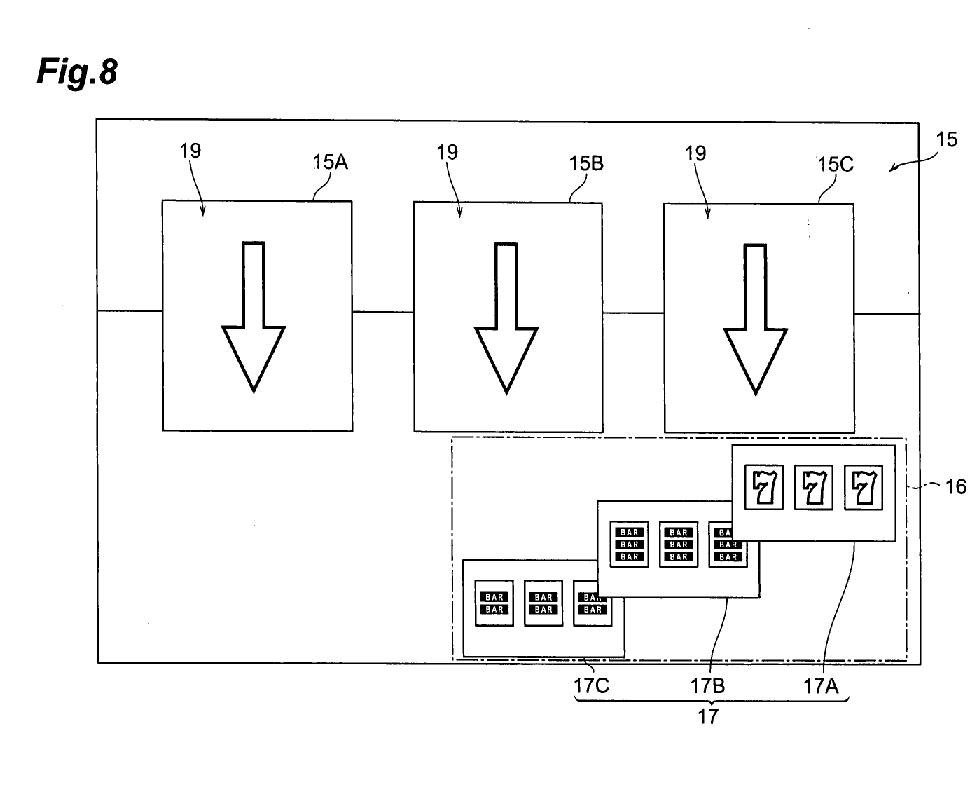

When the scroll process is started, the main CPU 32 performs processing of variable display of a plurality of symbols in each of the symbol areas 15A to 15C on the main display 3 by instructing the image control circuit 71 (process to display scroll display images) and in the subsequent Step S12, a process for displaying a winning combination history is carried out to display past winning combinations (combinations of past stopped symbols) in the image display area other than the symbol areas 15A to 15C (second display area; history display area 16). FIG. 8 shows the image display area 15 on the main display 3 in which the scroll process and the process for displaying winning combination history are carried out. In each of the symbol areas 15A to 15C located at substantially the center of the image display area 15, the scroll display images 19 are displayed as shown by outline arrows in FIG. 8, and past winning combinations 17A, 17B, 17C indicating winning in the past variable display game are displayed in the history display area 16 shown by being surrounded by a dashed line below the symbol areas 15A to 15C.

In the winning combination history display process, the main CPU 32 operates as the display control means in the present invention. The main CPU 32 searches the winning combination history table 41 (See FIG. 6), which will be described later, and obtains top three winning combinations (winning combinations of the first to the third ranks) by referring to the priority order. The priority order is the order to display the respective winning combinations on the main display 3. The main CPU 32 instructs the image control circuit 71 to display the winning combination history image 17 showing the past winning combinations in the descending order of the priority on the main display 3. In this embodiment, the winning combination 17A (See FIG. 8) with the lowest appearance probability (that is, difficult to win) among the three has the highest priority, while the priorities of the winning combinations 17B, 17C are lowered in this order according to the appearance probability. The visually recognized winning history image 17 is displayed in the history display area 16 in the order from the winning combination 17A so as to be overlapped one after another from below. In the slot machine 1, the main CPU 32 displays the past winning combinations (combination of the stopped symbols determined as winning combinations) in the history display areas 16 in the current variable display game subsequent to the past variable display game (past variable display game when the combination of the stopped symbols stored in the storage device 40 is displayed in the stopped state) in this way. Also, in the slot machine 1, when the plurality of symbols is variably displayed in the current variable display game, the past wining symbols are displayed on the history display area 16. That is, the specific combination of the stopped symbols is displayed in the history display area 16 (second display area) of the image display area 15 in another variable display game after the variable display game in which the specific combination is displayed in a stopped state in the symbol areas 15A to 15C (first display area) of the image display area 15.

At the subsequent Step 13, the main CPU 32 carries out the stop control process, lowers a speed of scrolling and displays the stop symbols corresponding to the result of the base game drawing process at Step 10 in the respective symbol areas 15A to 15C. Then, the symbols displayed in the respective symbol areas 15A to 15C here are the stopped symbols in the present invention.

At the subsequent Step 14, the main CPU 32 operates as the winning combination determining means in the present invention and determines if the combination of the stopped symbols in the respective symbol areas 15A to 15C is the winning combination indicating winning of the variable display game. The main CPU 32 determines whether “1” was set to the winning combination flag in the base game drawing process (Step 10) and if “1” was set, the symbol is determined as winning and the process for setting priority order (Step 15) and the subsequent process for storing winning combination (Step 16) are carried out. However, if “1” was not set, the base game process is finished without carrying out the process for setting priority order (Step 15) or the process for storing winning combination (Step 16). In the following explanation of this preferred embodiment, since “1” was set to the winning combination flag, the symbol is determined as winning, and the program proceeds to Step 15.

When the process for setting priority order is started at Step 15, the main CPU 32 operates as the priority order setting means in the present invention and sets the priority order when the combination of the stopped symbols determined as winning (determined combination) is displayed on the main display 3. Here, the main CPU 32 refers to the winning combination history table 41 stored in the storage device 40 (See FIG. 6A) and reads out the already stored winning combinations and appearance probabilities corresponding to the winning combinations. Then the main CPU 32 compares the appearance probabilities of the wining symbols read out of the winning combination history table 41 with the appearance probability of the determined combination, sorts them so that the one with lower appearance probability comes to the top and sets the priorities to the combinations of the plural stopped symbols.

In this explanation of the embodiment, the determined combination is “cherry, cherry, cherry” and the appearance probability is “1/7447”. When this is compared with the appearance probability of the other winning combinations read out of the winning combination history table 41, it is lower than the appearance probability of “1/4965” of the second-rank winning combination of “3BAR, 3BAR, 3BAR”. Therefore, the main CPU 32 sets the priority of the specific winning combination as second and also brings down the original second-rank winning combination of “3BAR, 3BAR, 3BAR” and the other winning combinations with the lower priorities.

In this embodiment, the lower the appearance probability of the symbol is, the higher the payout is, and even if a symbol with high payout is set with a higher priority, the order of priority will not change. However, if payouts are different among those with the same appearance probabilities or vice versa, the order of priority will change depending on which to be based on, appearance probabilities or payouts.

At the subsequent Step 16, the process for storing winning combination is carried out. Here, the main CPU 32 updates the winning combination history table 41 stored in the storage device 40 and stores the determined combinations and the other winning combinations in the storage device 40 according to the priorities set at the process for setting priority order (Step 15). Table (A) of FIG. 6 shows the winning combination history table 41 before update, and Table (B) of FIG. 6 shows a winning combination history table 42 after update. In the winning combination history table 42 after update, the determined combination of “cherry, cherry, cherry” is stored to be the second rank in the priority order. At Steps 15, 16, every time the combination of the stopped symbols in the respective symbol areas 15A to 15C is determined as a winning combination, the priority is set according to the appearance probability of the wining symbol and stored in the storage device 40. When the process for storing winning combination is finished, the base game process is finished.

When the base game process is finished, the program proceeds to Step 3, where the main CPU 32 determines if the transition condition is met or not and the game mode should be made to transit to the bonus game (that is, special game mode) or not from the result of the base game process. If the transition condition is satisfied, in the slot machine 1, that is, if predetermined information (“1” in this preferred embodiment) is set to the bonus flag (other than that, transition availability determination may be made based on a condition when the stopped symbol of the specific symbol area (for example, symbol area 15B) is determined as a specific symbol), the main CPU 32 determines that transition is allowed. Then, the main CPU 32 operates as the transition means and makes the game mode transit to the bonus game. When the game mode transits to the bonus game, the processing proceeds to Step 4 and the bonus game process is carried out.

(Bonus Game Process)

When the main CPU 32 determines that the game mode is allowed to transit from the base game mode to the special game mode and the bonus game process is started, a free game is performed for a predetermined number of times. The free game means that the variable display game can be played without requiring input of coins by the player, which is advantageous for the player. In the bonus game where this free game is to be played, drawing process (corresponding to the base game drawing process), scroll process and stop control process are carried out as in the base game process, and the bonus game process is finished.

Here, the winning combinations may be also displayed in the bonus game process as in the base game process. That is, the main CPU 32 operates as the winning combination determining means, the display control means and the priority order setting means in the present invention. Accordingly, the main CPU 32 determines if the combination of symbols displayed in a stopped state in the free game is a winning combination or not, and sets the priority of the winning combination. Then, the main CPU 32 stores the winning combination in the storage device 40 according to the set priority and may display the winning combination in the history display area 16 of the main display 3 according to the priority.

When the bonus game process is finished, the program proceeds to Step 5, where coins according to the winning in the base game and the bonus game are paid out. Here, the main CPU 32 displays a screen on the touch panel 3a, on which the display code (3 alphabetic letters) of the player is to be inputted by the player. After the display code has been inputted, the main CPU 32 stores the display code, the winning combination won by the player, the number of paid-out coins and the date in the storage device 40.

Then, when the ranking display process is started at Step 6, the main CPU 32 reads out the display code, the winning combination won by the player, the number of paid-out coins and date (hereinafter referred to as “ranking data”) stored in the storage device 40. The main CPU 32 instructs the image control circuit 71 to display the ranking image 18 (image in which the winning combinations from the first to the fourth ranks are displayed in a row from up to down in the order from the largest number of paid-out coins) as shown in FIG. 9 on the sub display 4 based on the read-out ranking data. It is to be noted that the ranking image 18 has a letter portion 18A of “SCORE”, respective winning combination portions 18B from the first to the fourth ranks, and a ranking contents display portion 18C showing the ranks of the respective winning combinations, the number of paid-out coins, the display code and the date. When the ranking display process is finished, the main process is finished.

As mentioned above, in the slot machine 1, the result of the variable display game is displayed on the main display as the winning combination. Therefore, players can grasp the results of the past variable display games more easily and recognizes the past winning combinations actually having appeared on the slot machine 1. This results in improving interest in the variable game, and the players will hardly get tired of the variable display game. Particularly, players can retain the winning combination until the history reset button 20 is pressed and can play the base game while watching the past winning combinations. This makes the winning combinations impressive and reinforces the pleasure. Also, a player's wish to see a certain winning combination in the past again can be met. Moreover, since the winning combinations with higher priorities, for example, are displayed on the main display 3 due to appearance of the winning combinations, changes in the variable display game are generated, and players will not get tired of the game easily and are motivated to play the variable display game repeatedly.

Also, in the slot machine 1, the combination of the stopped symbols determined as a winning combination in the past variable display game is displayed when variable display of plural symbols are carried out in the respective symbol areas 15A to 15C in the current variable display game. Therefore, the players can confirm the past winning combinations during the variable display of the plural symbols, and the players might expect another appearance of the winning combination in the variable display game or play the variable display game aiming for the symbols with payouts larger than the past winning one. This will generate a new interest and reinforces the pleasure of the variable display game.

Also, when a probability of appearance as a winning combination is lowered, a rarity value of the winning combination is increased. Accordingly, when the winning combination actually appears, willingness to store the winning combination or a demand to keep a strong impression of the winning combination in mind will further rise. In the slot machine 1, the winning combinations which are difficult to be formed as a combination of stopped symbols displayed in the respective symbol areas 15A to 15C (winning combinations with lower appearance probabilities) are set with relatively higher priorities than the other winning combinations so that the winning combinations with lower appearance probabilities are displayed with priority on the main display 3 to satisfy the players' desire.

Moreover, in the slot machine 1, the winning combinations with higher payouts are given relatively higher priorities than the other winning combinations, and a part of top-rank winning combinations with the higher priorities (only 3 in this embodiment) are displayed on the main display 3. In this way, since the higher the payout is, the larger the benefits are for the player, the winning combinations with higher payouts easily impress the players. Therefore, when the winning combinations with higher payouts are displayed on the main display with priority, the players will play the variable display game paying more attention to the displayed winning combinations, which further reinforces pleasure of the variable display game.

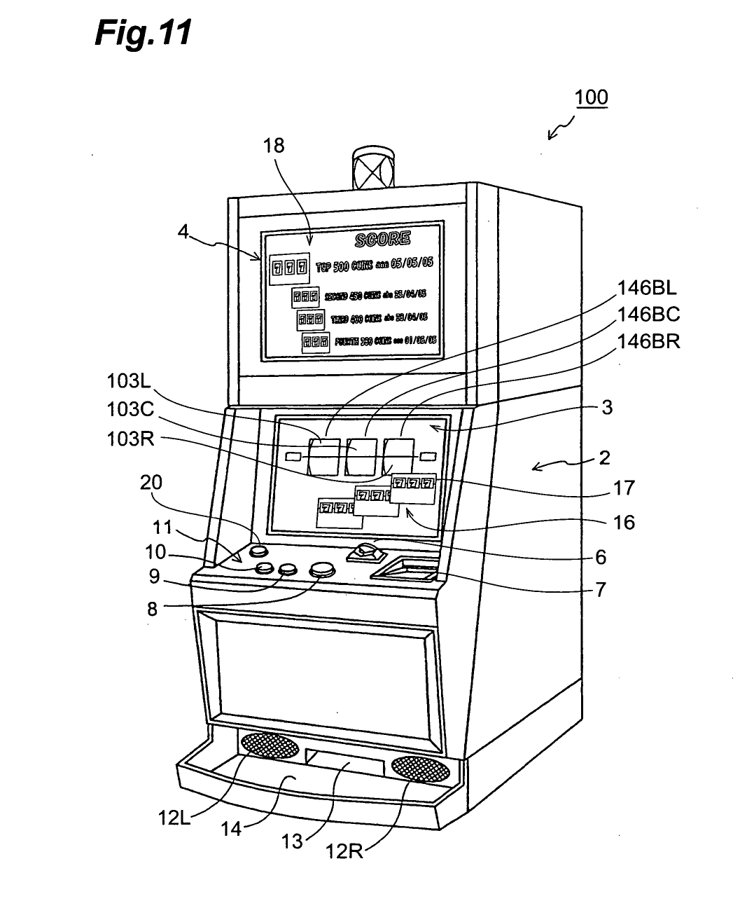

In the above embodiment, the slot machine 1 in which the variable display means includes the main display 3 representing a reel is used as an example for description. As another example, the present invention may be applied to a reel-type slot machine 100 having a plurality of mechanical reels on which a plurality of symbols are depicted. In the reel-type slot machine 100, the plurality of mechanical reels constitutes the variable display means, as shown in FIG. 11. In the following description, the same construction as in the slot machine 1 will be given the same reference numerals, whose detailed description will be omitted.

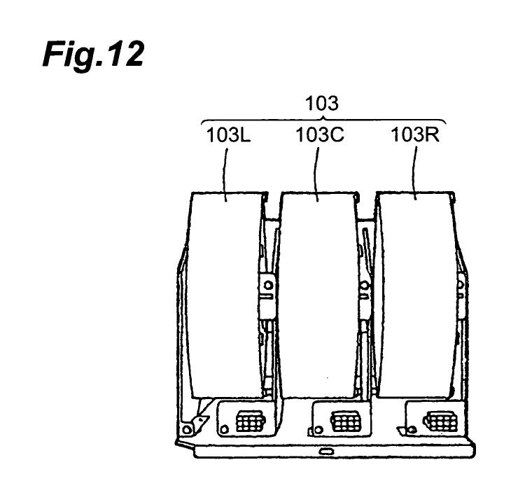

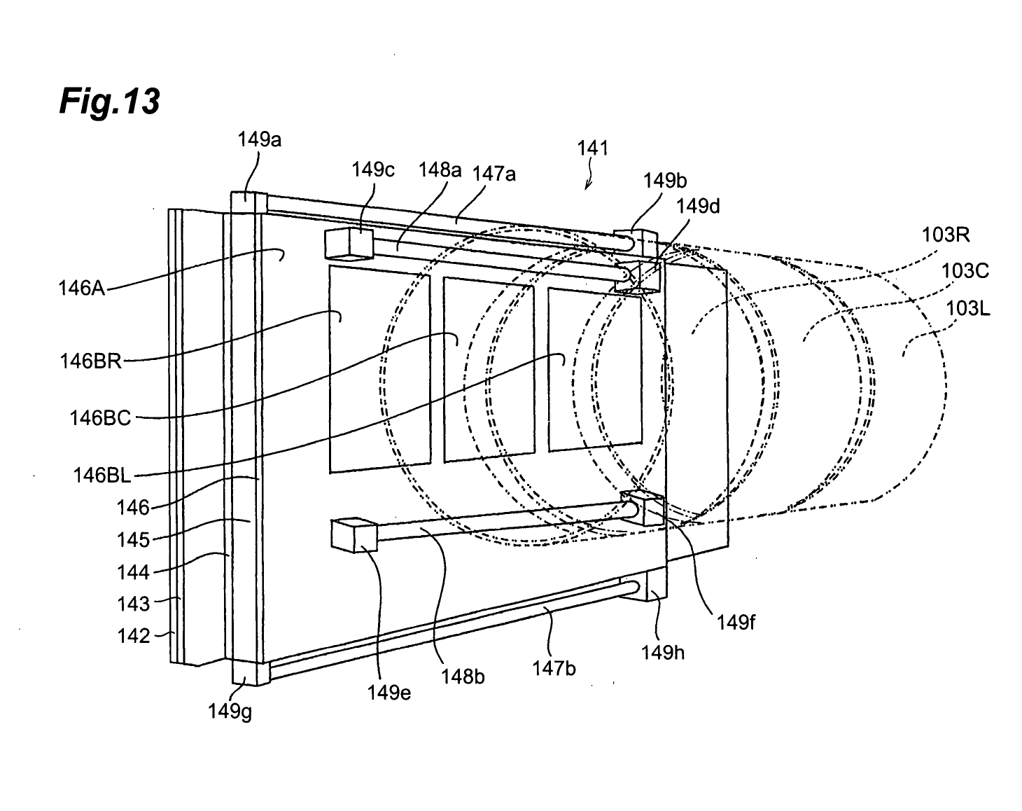

In the case of this reel-type slot machine 100, a reel unit 103 in which three mechanical reels 103L, 103C and 103R shown in FIGS. 12 and 13 are rotatably arranged in a lateral single row in the cabinet 2, for example, and, as shown in FIG. 13, a liquid crystal display device 141 arranged on the front face side across the reels 103L, 103C and 103R are provided. In each of the reels 103L, 103C and 103R, a reel sheet on which a plurality of symbols is depicted is attached to the side face portion, respectively, and they are rotated by a stepping motor, not shown, arranged inside.

The liquid crystal display device 141 has a protective glass 142 and a display plate 143 having translucency, a liquid crystal panel 144 and a light guide plate 145 and moreover has a reflective film 146, fluorescent lamps 147a, 147b, 148a and 148b as white light sources, lamp holders 149a to 149h and a flexible board (not shown) including a table carrier package (TCP) connected to a terminal portion of the liquid crystal panel 144 and on which an IC for driving the liquid crystal panel 144 is mounted.

The liquid crystal panel 144 displays white in a state where no voltage is applied to the liquid crystal (light is transmitted to the display face side and the light can be seen from the outside) and is constituted as normally white that the reels 103L, 103C and 103R can be visually recognized from the front side. The light guide plate 145 is provided to guide the light from the fluorescent lamps 147a, 147b to the liquid crystal panel 144. The reflective film 146 is provided to reflect the light introduced into the light guide plate 145 toward the surface side of the light guide plate 145 and has a reflective area 146A for reflecting incident light and non-reflective areas 146BL, 146BC and 146BR as light transmission portions for transmitting the incident light without reflecting the incident light. The non-reflective areas 146BL, 146BC and 146BR are arranged in front of three symbols in a vertical direction which will appear when rotation of 103L, 103C and 103R is stopped.

In the case of the reel-type slot machine having the above construction, by rotation of the reels 103L, 103C and 103R, the plurality of symbols depicted on the side surfaces is variably displayed. Therefore, the liquid crystal display device 141 corresponds to the display means in the present invention. Further, the liquid crystal panel 144 corresponds to the image display area and the non-reflective areas 146BL, 146BC and 146BR correspond to a plural of the symbol areas in the present invention.

The embodiments of the present invention have been described as above based on the slot machine 1. However, the present invention is not limited to the above embodiments, but the number of symbol areas may be 6 or more. Also, the three symbol areas were aligned laterally, but they may be arranged vertically.

Moreover, it may be so constituted that the main CPU 32 operating as the winning combination determining means determines as a winning combination if one or more of a specific symbol (the Wild joker 92a, for example) is included.

Moreover, the slot machine 1 was set so that the winning combinations with lower appearance probabilities come to the top ranks of the priority order and they are displayed on the main display 3 according to the priority, but the priority may be set so that the winning combinations with higher payouts or those with the larger number of paying-out coins come to the top rank of the priority order. Further, it may be set so that the winning combinations with higher appearance probabilities, those with lower payouts or those with the smaller number of paying-out coins come to the top rank of the priority order.

Moreover, display of the winning combinations according to the priority order is not limited to the top three priorities (first to third ranks), but only the first rank or 4 or more ranks may be displayed. Further, display may be carried out only when the winning combination with the appearance probability lower or higher than a predetermined value appears.

Moreover, in the slot machine 1, the process for displaying winning combination history was performed after the scroll process, and then the scroll display image 19 and the past winning combinations 17A, 17B and 17C were displayed together. However, it may be so constituted that the winning combination history display process is carried out after the start reception process (before start of the base game process) and the past winning combinations are displayed before display of the scroll display image 19. Alternatively, after a new priority order is set by the process for setting priority order and the process for storing the winning combination is performed, the past already-displayed winning combinations may be rearranged for display after being changed to the winning combinations based on the new priority order.

Also, in the slot machine 1, the ranking image 18 was displayed on the sub display 4 after payout of coins is finished, but the ranking image may be displayed on the main display 3 during the game, that is, after the base game (or bonus game) is finished and before the next base game is started.

As mentioned above in detail, according to the present invention, past game results can be grasped more easily in the variable display game, and a gaming machine which players hardly get tired of playing games can be provided.

A gaming machine of the present invention is for playing a variable display game by variably displaying a plurality of symbols. The gaming machine comprises: a display means including a first display area which displays the plurality of symbols in a variable state and in a stopped state, and a second display area occupying at least a part of an area other than the first display area; a winning combination determining means for determining whether or not a combination of stopped symbols displayed in the stopped state in the first display area is a specific combination; and a display control means for displaying the specific combination in the second display area in another variable display game after the variable display game in which the specific combination is displayed in a stopped state in the first display area.

According to another aspect of the present invention, a gaming machine of the present invention is for playing a game operable upon a bet made by a player. The gaming machine may comprise a display including a first display area adapted to display the game and a second display area positioned in an area except for the first display area; and a processor in communication with the display, wherein the processor is operable to determine a game result and to display the game result on the second display area in another game after the game in which the game result is displayed in the first display area.

According to the present invention as above, since the combination of the stopped symbols which were stopped and displayed as the specific combination (winning combination) is displayed at a later variable display game, a player can grasp the past game results from the combinations of the stopped symbols which are displayed in the second display area (image display area other than the symbol areas). Particularly, since the symbol areas for variable display of symbols and the like are included in the image display area of the display means and the combination of the stopped symbols, which is a winning combination, is displayed in the image display area other than the symbol areas, the combination of the past stopped symbols are easily recognized by players playing the variable display game. Therefore, the combination of the stopped symbols displayed by the display means strongly impresses the players, and the players will pay attention to the combination of the symbols while playing the variable display game and hardly get tired of the game.

Moreover, the display control means in the above gaming machine may display the specific combination of the stopped symbols in the second display area of the display means during the variable display of the symbols in the first display area of the display means. From a different point of view, the processor of the gaming machine may control the display to display a combination of stopped symbols in the second display area of the display while controlling the display to variably display symbols in the first display area of the display.

According to the gaming machine as above, the specific combination of the stopped symbols, which may be a past winning combination, is displayed during variable display of a plurality of symbols in the symbol areas, and the players will pay more attention to the past winning combinations while playing the variable display game.

Moreover, by further providing a priority order setting means for setting a priority order when a plurality of the specific combinations of the stopped symbols are displayed in the second display area of the display means, the display control means may display the plurality of the specific combinations in the second display area according to the priority order set by the priority order setting means. From a different point of view, the processor may set a priority order when a plurality of the combinations of stopped symbols are displayed in the second display area of the display, and may control the display to display the plurality of the combinations in the second display area according to the priority order.

Further, the priority order setting means may set the priority order according to a difficulty to be formed as a combination of the stopped symbols displayed in first display area of the display means. From a different point of view, the processor may set the priority order according to a difficulty to be formed as a combination of the stopped symbols displayed in the first display area of the display.

According to the gaming machine as above, the combination of the stopped symbols with the higher priority order is displayed with priority.

The present invention may be applied to, for example, a gaming machine in which a specific combination is a winning combination indicating a variable display game is won and a gaming machine in which a processor determines a game result relating to a variable display game in which a specific combination is a winning combination indicating the variable display game is won.

What is claimed is:

1. A gaming machine for playing a variable display game by variably displaying a plurality of symbols, comprising:
a display including a first display area which displays the plurality of symbols in a variable state and in a stopped state, and a second display area occupying at least a part of a display area other than the first display area;
a processor which determines whether or not a combination of stopped symbols displayed in the stopped state in the first display area is a specific combination, and which displays the specific combination in the second display area in another variable display game after the variable display game in which the specific combination is displayed in a stopped state in the first display area.

2. The gaming machine according to claim 1,
wherein the processor controls the display to display the specific combination of the stopped symbols in the second display area of the display during the variable display of the symbols in the first display area of the display.

3. The gaming machine according to claim 1,
wherein the processor sets a priority order when a plurality of the specific combinations of the stopped symbols are displayed in the second display area of the display, and controls the display to display the plurality of the specific combinations in the second display area according to the priority order.

4. The gaming machine according to claim 3,
wherein the processor sets the priority order according to a difficulty to be formed as a combination of the stopped symbols displayed in the first display area of the display.

5. The gaming machine according to claim 1,
wherein the specific combination is a winning combination indicating the variable display game is won.

6. A gaming machine for playing a game operable upon a bet made by a player, comprising:
a display including a first display area adapted to display the game and a second display area positioned in an area except for the first display area; and
a processor in communication with the display,
wherein the processor is operable to determine a game result and to display the game result on the second display area in another game after the game in which the game result is displayed in the first display area.

7. The gaming machine according to claim 6,
wherein the processor controls the display to display a combination of stopped symbols in the second display area of the display while controlling the display to variably display symbols in the first display area of the display.

8. The gaming machine according to claim 6,
wherein the processor sets a priority order when a plurality of the combinations of stopped symbols are displayed in the second display area of the display, and controls the display to display the plurality of the combinations in the second display area according to the priority order.

9. The gaming machine according to claim 8,
wherein the processor sets the priority order according to a difficulty to be formed as a combination of the stopped symbols displayed in the first display area of the display.

10. The gaming machine according to claim 6,
wherein the processor determined the game result relating to a variable display game in which the specific combination is a winning combination indicating the variable display game is won.
